(19) United States
(12) Patent Application Publication
(10) Pub. No.: US 2026/0296310 A1
(43) Pub. Date: Oct. 1, 2026

(54) Method for Operating a Vehicle, and Vehicle

(71) Applicant: Volkswagen Aktiengesellschaft, Wolfsburg (DE)

(72) Inventors: Stefan Gläser, Braunschweig (DE); Monique Engel, Knesebeck (DE); Michael Weng, Berlin (DE)

(73) Assignee: Volkswagen Aktiengesellschaft, Wolfsburg (DE)

(21) Appl. No.: 18/881,387

(22) PCT Filed: Jun. 23, 2023
(86) PCT No.: PCT/EP2023/067168

§ 371 Date: Jan. 6, 2025

(30) Foreign Application Priority Data
Jul. 8, 2022 (DE) 10 2022 207 004.6

(51) Int. Cl. B60Q 9/00; B60W 30/095; H04W 4/46; H04W 4/90

(52) U.S. Cl. CPC B60Q 9/008; B60W 30/095; H04W 4/46; H04W 4/90; B60W 2540/30; B60W 2554/4046; B60W 2756/10

(57) ABSTRACT

The disclosure relates to a method for operating a vehicle, wherein the presence of an emergency situation involving the vehicle is detected. After the presence of an emergency situation has been detected, a danger zone is determined in the form of at least once future trajectory or a trajectory swarm of possible future trajectories of the vehicle and information describing the danger zone is communicated to other vehicles and/or infrastructure devices in the surroundings of the vehicle by way of communication device. Alternatively or additionally, a warning signal is output to warn other road users impacted by the danger zone.

### CROSS-REFERENCE TO RELATED APPLICATIONS

This application claims priority to German Patent Application DE 10 2022 207 004.6, filed on Jul. 8, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for operating a vehicle and to a vehicle. Both in the case of manually controlled vehicles and in the case of semi-autonomously and fully autonomously driving vehicles, emergency situations may occur which must be handled in a suitable manner.

### SUMMARY

A need exists to provide a method and a vehicle by means of which it is possible to react to emergency situations in an improved manner. In particular, other road users are intended to be informed that an emergency situation is present.

The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of an embodiment of a vehicle;

FIG. 2 is a schematic representation for illustrating an example emergency situation and an example danger zone; and

FIG. 3 is a schematic flow diagram of an embodiment of a method for operating a vehicle.

### DESCRIPTION

The details of one or more embodiments are set forth in the accompanying drawings and the description below. Other features will be apparent from the description, drawings, and from the claims.

In the Following Description of Embodiments of the Invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In particular, a method for operating a vehicle is made available, wherein the presence of an emergency situation of the vehicle is detected, wherein, after the presence of an emergency situation has been detected:
a) a danger zone is determined in the form of at least one future trajectory or a trajectory swarm of possible future trajectories of the vehicle, and wherein
b1) information describing the danger zone is communicated to other vehicles and/or infrastructure apparatuses in the surroundings of the vehicle by way of a communication apparatus,
   and/or
b2) a warning signal is output to warn other users impacted by the danger zone.

Furthermore, a vehicle is in particular provided, comprising a driver assistance system, wherein the driver assistance system is configured to detect the presence of an emergency situation of the vehicle and, after the presence of an emergency situation has been detected:
a) to determine a danger zone in the form of at least one future trajectory or a trajectory swarm of possible future trajectories of the vehicle,
   and
b1 to communicate information describing the danger zone to other vehicles and/or infrastructure apparatuses in the surroundings of the vehicle by way of a communication apparatus of the vehicle,
   and/or
b2) to output a warning signal to warn other roads users impacted by the danger zone.

The method and the vehicle make it possible to warn surroundings of the vehicle of the presence of an emergency situation in an improved manner. Other road users located in the surroundings can then react to the emergency situation and, for example, adapt a relevant behavior to the behavior of the vehicle. For this purpose, it is provided that the presence of an emergency situation of the vehicle is detected. If the presence of an emergency situation was detected, a danger zone is determined in the form of at least one future trajectory or a trajectory swarm of possible future trajectories of the vehicle. The at least one future trajectory may, for example, be determined by means of a trajectory planner of the driver assistance system and/or obtained therefrom. Typically, a trajectory planner of this kind determines a plurality of possible future trajectories that can be executed by the vehicle in the current surroundings proceeding from recorded sensor data of the surroundings and a surroundings model generated here from. The danger zone comprises, in particular, the trajectories which can be implemented by the vehicle up to a specified point in time and/or point in space in the surroundings. In particular, a trajectory swarm can be generated from a desired trajectory (e. g. merging into the adjacent lane), a planned trajectory, and further possible trajectories. As a rule, the trajectories are linked to a probability of occurrence and/or another evaluation variable by means of which a cost value is assigned to the trajectories, for example proceeding from a cost function. The cost function may include and/or reflect costs of the vehicle as well as costs of other road users. Here, accelerations, steering angles, behavior (e. g. driving in the lane, or lane is/was left) that complies or does not comply with rules, etc., can be taken into account. Based on a (total) cost value calculated for a trajectory by means of the cost function, the trajectory planner can then select an optimal planned trajectory to be implemented. Information describing the determined danger zone is communicated to other vehicles and/or infrastructure apparatuses in the surroundings of the vehicle by way of a communication apparatus of the vehicle. Here, in particular, vehicle-to-everything (V2X) and/or car-to-car (C2C) communication is used. In principle, however, other suitable, in particular wireless, communication methods can be used, for example Wi-Fi/WLAN, Bluetooth, mobile communication (LTE, 5G, etc.), etc. Alternatively or additionally, a warning signal for warning other road users impacted by the hazard zone is output and/or the output is prompted. A warning signal of this kind may, for example, be or comprise an acoustic warning signal (generated, e. g., by way of an acoustic signal generator, for example a horn, a loudspeaker, etc.) and/or an optical warning signal (generated, e.g., by way of an optical signal generator, for example warning lights, flashing light, etc.). It is provided, in particular, that other road users in the danger zone are determined proceeding from the determined danger zone in order to warn said other road users in a targeted manner.

A benefit of the method and vehicle is that surroundings of the vehicle, in particular other road users present in the surroundings, can be warned in an improved manner. By notifying of the danger zone, other road users are, in particular directly, given the possibility to adapt their own behavior and their own planning to the present emergency situation of the vehicle.

Furthermore, by notifying of the danger zone, other road users also immediately gain an insight into a type and extent of the present emergency situation of the vehicle. In the case of a vehicle that is unable to maneuver, the communicated future trajectories indicate, in particular, that the vehicle has little or no room for altering its behavior due to the present emergency situation. As a result, other road users impacted by the danger zone can then adapt a relevant behavior accordingly. For this purpose, said other road users can adapt cost functions used, for example, in trajectory planning accordingly in order to favor behavior adapted to the emergency situation or else to evaluate it with lower costs.

When the danger zone is determined, same is estimated and/or predicted, in particular, with the aid of estimated trajectories of a trajectory planner of the driver assistance system. Vehicle properties (e.g. a mass, a wheel base, dimensions, motorization, etc.), a vehicle state (e. g. vehicle age, vehicle loading, detected damage, e.g. on the wheels, etc.), driving physics (e.g. friction values, cornering forces, etc.), road properties (e.g. a road surface, curbs, a road course, uphill/downhill slopes, etc.), and/or a current road state (e.g. wetness, black ice, etc.), in particular, can be taken into account here. Map data can also be taken into account, for example in order to incorporate a road course (ahead).

A vehicle is, in particular, a motor vehicle. In principle, however, the vehicle may also be another land or rail vehicle or watercraft, aircraft, or spacecraft, for example an air taxi or a drone.

Parts of the driver assistance system may be designed individually or collectively as a combination of hardware and software, for example as program code that is executed on a microcontroller or microprocessor. However, it is also possible for the parts to be designed individually or collectively as an application-specific integrated circuit (ASIC) and/or field-programmable gate array (FPGA).

In some embodiments, it is provided that, in b1), a message is additionally communicated to other vehicles and/or infrastructure apparatuses in the surroundings of the vehicle by way of the communication apparatus, which message comprises information that the vehicle is in an emergency situation. As a result, a backward compatibility can be ensured. Other vehicles, other road users and/or infrastructure apparatuses that cannot receive trajectories but rather merely simple messages can then still be informed of the presence of the emergency situation. Knowledge of the emergency situation allows, for example, another vehicle to switch to a more defensive driving style and/or to reduce a speed.

In some embodiments, it is provided that, after the presence of the emergency situation has been detected, it is checked whether the vehicle can still be extricated from the detected emergency situation, wherein the measures b1) and/or b2) are only executed if this is not the case. As a result, further information, for example from an interior of the vehicle, can be taken into account. For example, the behavior exhibited by a driver and/or passengers of the vehicle can be monitored. If the driver and/or a passenger attempts, for example, to defuse the emergency situation, the execution of the measures b1) and/or b2) can be delayed, for example. If the emergency situation can be defused, the measures b1) and/or b2) are not executed. However, if the emergency situation cannot be defused, the measures b1) and/or b2) are executed.

In some embodiments, it is provided that the future trajectories of the trajectory swarm are selected such that a probability of occurrence assigned in each case to the future trajectories is equal to or greater than a specified threshold value or such that a cost value assigned in each case to the future trajectories is less than a specified threshold value. As a result, a number of trajectories to be communicated can be limited. This is based on the idea that trajectories with a lower probability of occurrence or else excessively high cost values will likely not occur and thus are less relevant for evaluating and reacting to the emergency situation of the vehicle. In particular, a data volume that must be communicated can be reduced as a result.

In some embodiments, it is provided that a driving behavior is monitored for the detection of an emergency situation. For this purpose, in particular, a behavior of the vehicle can be evaluated with respect to the surroundings. For example, sensor data of one or more surroundings sensors of the vehicle can be evaluated for this purpose. For example, an imminent collision can be detected. Alternatively or additionally, the trajectory planner can establish that a planned trajectory is on a collision course with the (estimated or received) trajectories of other road users. Further examples include leaving the lane, for example leaving the lane can be detected for this purpose, wherein it is detected that this has taken place without a turn signal being activated. It can further be detected that the vehicle is driverless, for example if a human driver can no longer control the vehicle for health reasons or because a system for automated open-loop/closed-loop control (self-driving system, SDS) has failed. Furthermore, the presence of an emergency stop can also be established, for example if it is or has been established that the vehicle is coming or has come to a standstill on a shoulder of a highway or country road. The sensor and/or control data can then, for example, be evaluated by way of pattern recognition methods and machine learning and artificial intelligence methods. The pattern recognition methods and/or machine learning and artificial intelligence methods can, for example, be trained with the aid of training data that have been obtained empirically and/or in simulations.

In some embodiments, it is provided that driving dynamics of the vehicle are monitored for the detection of an emergency situation. For example, for this purpose, sensor data and/or control data of an anti-lock braking system (ABS), an electronic stability program (ESP), and/or other open-loop and/or closed-loop control systems of the open-loop/closed-loop driving dynamics control, for example a lane assist, can be evaluated. The data can then, for example, be evaluated by way of pattern recognition methods and machine learning and artificial intelligence methods. The pattern recognition methods and/or machine learning and artificial intelligence methods can, for example, be trained with the aid of training data that have been obtained empirically and/or in simulations.

In some embodiments, it is provided that a vehicle-driving entity is monitored for the detection of an emergency situation. For example, vital functions and/or a behavior/characteristics of a human driver can be monitored. For this purpose, one or more sensors may be provided, for example an interior camera, steering wheel sensors, and/or seat sensors. The recorded sensor data of these sensors can then, for example, also be evaluated by way of pattern recognition methods and machine learning and artificial intelligence methods. For example, a head position, a head inclination, the degree to which eyelids are open, a viewing direction, and/or a temperature of visible skin surfaces can be evaluated here. By way of a steering wheel sensor, a pulse, a skin moistness, and/or a skin temperature, for example, can be detected, and these can then also be evaluated in order to determine vital functions of the driver. However, the vehicle-driving entity may also be a system for automated open-loop/closed-loop control of longitudinal and lateral guidance of the vehicle (self-driving system, SDS). An SDS of this kind can then be monitored based on control and/or measurement data in order to ensure functionality of the SDS. Here, too, pattern recognition methods and machine learning and artificial intelligence methods can be used to detect a malfunction. The pattern recognition methods and/or machine learning and artificial intelligence methods can, for example, be trained with the aid of training data that have been obtained empirically and/or in simulations.

In some embodiments, it is provided that a behavior of other road users in surroundings of the vehicle is taken into account when determining the danger zone. As a result, the danger zone can already be determined in consideration of a possible change in behavior of said other road users. For example, it may be the case that another road user has already detected the presence of the emergency situation of the vehicle themselves and has subsequently changed their own behavior, for example by reducing a speed or by using and/or executing another planned trajectory. In order to take account of the behavior of the other road users, sensor data of the surroundings sensors of the vehicle, in particular, are evaluated, for example by way of pattern recognition methods and/or machine learning and artificial intelligence methods.

In some embodiments, it is provided that, in order to take account of the behavior of other vehicles in the surroundings, current and/or future trajectories of the other vehicles in the surroundings are received and/or queried. As a result, the current and planned behavior of the other vehicles can be efficiently taken into account. In particular, those embodiments make it possible to save time, since the current and/or future trajectories of the other vehicles do not have to be estimated in a time-consuming and computing-intensive manner based on sensor data of the surroundings sensors of the vehicle, but rather can be directly obtained from the other vehicles. In particular, both desired and planned trajectories of the other vehicles can be received and/or queried.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The benefits of the embodiments of the vehicle in this context are always the same as for the embodiments of the method.

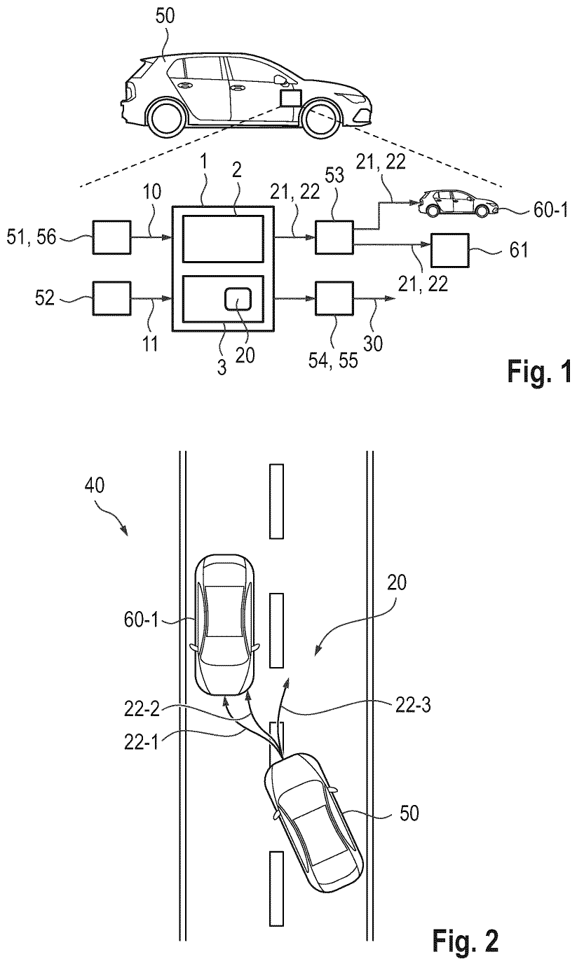

FIG. 1 is a schematic representation of an embodiment of the vehicle 50. The vehicle 50 comprises a driver assistance system 1. The method described in this disclosure is explained in more detail in the following based on the vehicle 50.

The driver assistance system 1 comprises a computing apparatus 2 and a memory 3. The driver assistance system 1 is configured to detect the presence of an emergency situation of the vehicle 50 and, after the presence of an emergency situation has been detected:
a) to determine a danger zone 20 in the form of at least one future trajectory 22-x (FIG. 2) or a trajectory swarm of possible future trajectories 22-x of the vehicle 50, and
b1) to communicate information 21 describing the danger zone 20 to other vehicles 60-1 and/or infrastructure apparatuses 61 in the surroundings of the vehicle 50 by way of a communication apparatus 53 (in particular V2X and/or C2C) of the vehicle 50, and/or
b2) to prompt output of a warning signal 30 to warn other roads users 60-x impacted by the danger zone 20.

The warning signal 30 is output, for example, by means of an acoustic warning apparatus 54 (e.g. acoustic signal generator) of the vehicle 50 (e.g. a horn or external loudspeaker) and/or by means of an optical warning apparatus 55 (e.g. optical signal generator) of the vehicle 50 (e.g. a turn signal and/or other warning lights).

To detect the emergency situation, the driver assistance system 1 is fed, for example, sensor data 10 from surroundings sensors 51 of the vehicle 50 and/or control and measurement data 11 from control units 52 of the vehicle 50. Said data are then evaluated by the computing apparatus 2 and, for example, analyzed for patterns for the presence of an emergency situation. Patterns of this kind may, for example, be determined with the aid of series of empirical tests and/or in simulations. Examples of emergency situations include: a loss of consciousness of the driver, an imminent collision between the vehicle and an obstacle or another vehicle, an inability of the vehicle to maneuver, or an emergency stop. During the evaluation, it is also o possible to use machine learning and artificial intelligence methods that have been trained with the aid of the data generated empirically and/or in simulations.

The danger zone 20 is, in particular, determined by means of a trajectory planner (not shown) that may be part of the driver assistance system 1 and/or be provided by it. The danger zone 20 contains a trajectory swarm, wherein the trajectory swarm contains future trajectories of the vehicle 50 executed by the vehicle 50 with a probability of occurrence assigned to each of these.

FIG. 2 is a schematic representation of a danger zone 20 in the surroundings of the vehicle 50 based on a example emergency situation 40. In the example, the emergency situation 40 is intended to be a possible collision between the vehicle 50 and another vehicle 60-1 on the opposite lane. In the exemplary representation, the danger zone 20 comprises three trajectories 22-x to which the probabilities of occurrence 40%, 30%, and 30% are assigned, respectively, from left to right in the representation. According to the method, said three trajectories 22-x may be communicated to the other vehicle 60-1. Alternatively, the trajectories 22-x may also be assigned a respective cost value for evaluation.

It can be provided that, in b1), a message 22 is additionally communicated to other vehicles 60-x and/or infrastructure apparatuses 61 in the surroundings of the vehicle 50 by way of the communication apparatus 53, which message comprises information that the vehicle 50 is in an emergency situation 40. It can also be provided that, after the presence of the emergency situation 40 has been detected, it is checked whether the vehicle 50 can still be extricated from the detected emergency situation 40, wherein the measures b1) and/or b2) are only executed if this is not the case.

It can be provided that the future trajectories 22-x of the trajectory swarm are selected such that a probability of occurrence assigned in each case to the future trajectories 22-x is equal to or greater than a specified threshold value or such that a cost value assigned in each case to the future trajectories 22-x is less than a specified threshold value. For example, trajectories 22-x with a probability of occurrence below a specified threshold value of 1%, 5%, or 10% may not be taken into account. Corresponding threshold values can be provided for the cost values.

It can be provided that a driving behavior is monitored for the detection of an emergency situation 40.

It can be provided that driving dynamics of the vehicle 50 are monitored for the detection of an emergency situation 40. For this purpose, the driver assistance system 2 may, in particular, evaluate the sensor data 10 and control and measurement data 11. It can be provided that a vehicle-driving entity is monitored for the detection of an emergency situation 40. For example, interior sensors 56 may be provided which monitor the vital functions of a human driver. If the vehicle-driving entity is a self-driving system (SDS), control data of the system can be monitored.

It can be provided that a behavior of other road users 60-x in surroundings of the vehicle 50 is taken into account when determining the danger zone 20. For this purpose, the driver assistance system 2 may, in particular, evaluate the sensor data 10 and control and measurement data 11.

Developing on this, it can be provided that, in order to take account of the behavior of other vehicles 60-1 in the surroundings, current and/or future trajectories (not shown) of the other vehicles 60-1 in the surroundings are received and/or queried.

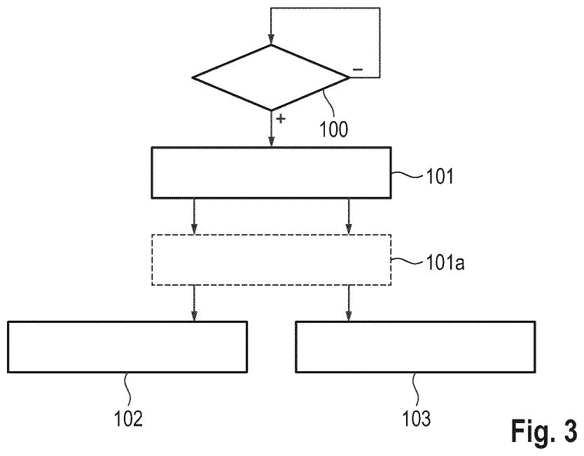

FIG. 3 is a schematic flow diagram of an embodiment of the method for operating a vehicle. The method is, in particular, executed by means of a vehicle and a driver assistance system according to any one of the embodiments described in the preceding.

In a measure 100, it is detected and checked whether or not an emergency situation of the vehicle is present. If no emergency situation is present, the measure 100 is repeated.

However, if the presence of an emergency situation is detected, in a measure 101, a danger zone is determined in the form of at least one future trajectory or a trajectory swarm of possible future trajectories of the vehicle. This takes place, in particular, by way of a trajectory planner that may also be part of the driver assistance system. The trajectory planner determines, in particular, multiple trajectories and estimates a probability of occurrence for each of the trajectories.

In a measure 102, information describing the danger zone is communicated to other vehicles and/or infrastructure apparatuses in the surroundings of the vehicle by way of a communication apparatus.

Alternatively or additionally, in a measure 103, a warning signal is output to warn other road users impacted by the danger zone. This may, for example, take place by means of an acoustic signal generator (e.g. horn, loudspeaker, signal horn, etc.) and/or optical signal generator (e.g. turn signal, lights, ground projection, etc.).

Within the scope of the measure 102, it can be provided that a message is additionally communicated to other vehicles and/or infrastructure apparatuses in the surroundings of the vehicle by way of the communication apparatus, which message comprises information that the vehicle is in an emergency situation.

Furthermore, in a measure 101a, it can be provided that, after the presence of the emergency situation has been detected, it is checked whether the vehicle can still be extricated from the detected emergency situation, wherein the measures 102 and/or 103 are only executed if this is not the case.

Further embodiments of the method have already been described in the preceding with reference to the vehicle.

### LIST OF REFERENCE NUMERALS

1 Driver assistance system
2 Computing apparatus
3 Memory
10 Sensor data
11 Control and measurement data
20 Danger zone
21 Information
22-x Trajectory
30 Warning signal
40 Emergency situation
50 Vehicle
51 Surroundings sensor(s)
52 Control unit(s)
53 Communication apparatus
54 Acoustic warning apparatus
55 Optical warning apparatus
56 Interior sensor(s)
60-x Other road users
60-1 Other vehicle
61 Infrastructure apparatus
100-103 Measures of the method

What is claimed is:

1-10. (canceled)

11. A method for operating a vehicle, comprising:
detecting the presence of an emergency situation of the vehicle; and after the presence of an emergency situation has been detected:
a) determining a danger zone in the form of at least one future trajectory or a trajectory swarm of possible future trajectories of the vehicle;
b1) communicating information describing the danger zone to other vehicles and/or infrastructure apparatuses in the surroundings of the vehicle by way of a communication apparatus; and/or
b2) outputting a warning signal to warn other roads users impacted by the danger zone.

12. The method of claim 11, wherein, in b1), a message is additionally communicated to other vehicles and/or infrastructure apparatuses in the surroundings of the vehicle by way of the communication apparatus, which message comprises information that the vehicle is in an emergency situation.

13. The method of claim 11, wherein, after the presence of the emergency situation has been detected, it is checked whether the vehicle can still be extricated from the detected emergency situation, wherein the measures b1) and/or b2) are only executed if this is not the case.

14. The method of claim 11, wherein the future trajectories of the trajectory swarm are selected such that a probability of occurrence assigned in each case to the future trajectories is equal to or greater than a specified threshold value or such that a cost value assigned in each case to the future trajectories is less than a specified threshold value.

15. The method of claim 11, wherein a driving behavior is monitored for the detection of an emergency situation.

16. The method of claim 11, wherein driving dynamics of the vehicle are monitored for the detection of an emergency situation.

17. The method of claim 11, wherein a vehicle-driving entity is monitored for the detection of an emergency situation.

18. The method of claim 11, wherein a behavior of other road users in surroundings of the vehicle is taken into account when determining the danger zone.

19. The method of claim 18, wherein, in order to take account of the behavior of other vehicles in the surroundings, current and/or future trajectories of the other vehicles in the surroundings are received and/or queried.

20. A vehicle, comprising:
a driver assistance system, wherein the driver assistance system is configured to detect the presence of an emergency situation of the vehicle and, after the presence of an emergency situation has been detected:
a) to determine a danger zone in the form of at least one future trajectory or a trajectory swarm of possible future trajectories of the vehicle; and
b1) to communicate information describing the danger zone to other vehicles and/or infrastructure apparatuses in the surroundings of the vehicle by way of a communication apparatus of the vehicle; and/or
b2) to prompt output of a warning signal to warn other roads users impacted by the danger zone.

21. The vehicle of claim 20, wherein, in b1), a message is additionally communicated to other vehicles and/or infrastructure apparatuses in the surroundings of the vehicle by way of the communication apparatus, which message comprises information that the vehicle is in an emergency situation.

22. The vehicle of claim 20, wherein, after the presence of the emergency situation has been detected, it is checked whether the vehicle can still be extricated from the detected emergency situation, wherein the measures b1) and/or b2) are only executed if this is not the case.

23. The vehicle of claim 20, wherein the future trajectories of the trajectory swarm are selected such that a probability of occurrence assigned in each case to the future trajectories is equal to or greater than a specified threshold value or such that a cost value assigned in each case to the future trajectories is less than a specified threshold value.

24. The vehicle of claim 20, wherein a driving behavior is monitored for the detection of an emergency situation.

25. The vehicle of claim 20, wherein driving dynamics of the vehicle are monitored for the detection of an emergency situation.

26. The vehicle of claim 20, wherein a vehicle-driving entity is monitored for the detection of an emergency situation.

27. The vehicle of claim 20, wherein a behavior of other road users in surroundings of the vehicle is taken into account when determining the danger zone.

28. The vehicle of claim 27, wherein, in order to take account of the behavior of other vehicles in the surroundings, current and/or future trajectories of the other vehicles in the surroundings are received and/or queried.

29. The method of claim 12, wherein, after the presence of the emergency situation has been detected, it is checked whether the vehicle can still be extricated from the detected emergency situation, wherein the measures b1) and/or b2) are only executed if this is not the case.

30. The method of claim 12, wherein the future trajectories of the trajectory swarm are selected such that a probability of occurrence assigned in each case to the future trajectories is equal to or greater than a specified threshold value or such that a cost value assigned in each case to the future trajectories is less than a specified threshold value.
